(19) United States
(12) Patent Application Publication
(10) Pub. No.: US 2018/0183961 A1
(43) Pub. Date: Jun. 28, 2018

(54) IMAGE FORMING APPARATUS, CONTROL METHOD THEREFOR, AND PROGRAM

(71) Applicant: Canon Kabushiki Kaisha, Tokyo (JP)

(72) Inventor: Masaki Kashiwagi, Hiratsuka-shi (JP)

(21) Appl. No.: 15/843,676

(22) Filed: Dec. 15, 2017

(30) Foreign Application Priority Data
Dec. 27, 2016 (JP) 2016-254091

(51) Int. Cl. H04N 1/00; H04N 1/34; G06Q 20/40; G06Q 30/02

(52) U.S. Cl. CPC H04N 1/00875; H04N 1/00854; H04N 1/00474; H04N 1/00344; H04L 63/083; G06Q 20/4014; G06Q 30/0283; H04N 2201/0094; H04N 2201/0074; H04N 1/34

(57) ABSTRACT

An image forming apparatus connected to a charging apparatus that collects a fee includes an authentication unit that authenticates users and a display that displays a screen enabling users to select between logging into the image forming apparatus based on being authenticated or by paying a fee using the charging apparatus.

### BACKGROUND

### Field

The present disclosure relates to an image forming apparatus, a control method therefor, and a program.

### Description of the Related Art

Image forming apparatuses are now usually installed in, for example, convenience stores to provide copy and print service. In such an operation form, a charge management device, such as a coin collecting device, is connected to the image forming apparatus, and a guest user can execute a copy job or a print job after inserting money into the coin collecting device. Administrators, such as salesclerks, can execute the copy job or the print job without paying money by switching between modes of the coin collecting device using, for example, a key. However, since image forming apparatuses installed in convenience stores are, for example, intended to be mainly used by guest users, their functions that would have been provided in general offices may be limited, even to administrators. Therefore, the above operation form may not be suitable for a situation, such as libraries, schools, etc., in which both guest users and employees use the image forming apparatus.

Japanese Patent Laid-Open No. 2011-059448 describes an image forming apparatus to which both a charge management device, such as a coin collecting device, and an authentication device, such as a card reader, are connected, in which money is inserted in the charge management device and a user logs in after user authentication using a card. Other users are not able to log into the image forming apparatus while the currently logged-in user is logged in.

Japanese Patent Laid-Open. No. 2015-123587 describes an image forming apparatus that logs out a user when the balance of money inserted into the charging apparatus reaches 0. A user is also logged out when a user who logged in using user authentication presses a logout button.

In an operation form in which guest users pay money and employees are subject to authentication using an ID or a password to use the image forming apparatus, if the guest users log in upon inserting money, the guest users need to insert money necessary for a copy job, etc., in advance. Otherwise, the user needs to insert any different in the amount due at the time of copy. Since the money needed for a copy job changes, for example, with the print setting, the guest user cannot know in advance how much money should be inserted before use.

Since other users cannot log in while a certain user is logged in, an employee, for example, will keep a guest user who will pay money to use the image forming apparatus waiting while the employee uses the image forming apparatus.

If a user is logged out because the remaining balance of money has reached 0, when shortage of money occurs due to abnormality of the apparatus during the copy, for example, the guest user is logged out even though not all the copies have been completed.

What is needed is an image forming apparatus where guest users can use by paying money and other users can use via authentication, for example, that improves convenience of guest users who pay money to use the image forming apparatus.

### SUMMARY

An aspect of an embodiment is an image forming apparatus connected to charging apparatus that collects a fee, including a display unit, an authentication unit configured to authenticate a user, a selection unit configured to cause a screen, displayed on the display unit, enabling a user to select between logging into the image forming apparatus based on authentication by the authentication unit or by paying a fee using the charging apparatus.

Further features will become apparent from the following description of exemplary embodiments with reference to the attached drawings.

### BRIEF DESCRIPTION OF THE DRAWINGS

Accompanying drawings are included in the specification, constitute a part of the specification, illustrate embodiments of the present disclosure, and are used to describe a principle of the present disclosure together with the description.

FIG. 1 is a block diagram illustrating a system configuration which includes an image forming apparatus according to an embodiment of the present disclosure.

FIG. 2 is a block diagram illustrating a module configuration of a control program (controller software) of an image forming apparatus according to an embodiment.

FIG. 3 is a top view of an operation panel provided with a display unit and an operation unit of an image forming apparatus according to an embodiment.

FIG. 4 illustrates an example of a user selection screen displayed on a display unit when an image forming apparatus according to an embodiment is started.

FIG. 5 illustrates an example of a login screen to be displayed on a display unit of an image forming apparatus according to an embodiment.

FIG. 6 is a conceptual diagram of a user management table held in a storage apparatus control unit of an image forming apparatus according to an embodiment.

FIGS. 7A and 7B each illustrate an example of a main menu screen displayed on a display unit when a user logs in an image forming apparatus according to an embodiment.

FIG. 8 is a flowchart illustrating a process after a user logs in until logs out in an image forming apparatus according to an embodiment.

FIG. 9 is a flowchart illustrating a process after a user logs in until logs out in an image forming apparatus according to an embodiment.

FIG. 10 is a flowchart illustrating an example of a process in which an image forming apparatus according to an embodiment executes a job in S824 of FIG. 9.

FIG. 11 illustrates an example of a screen for notifying a user of shortage of money displayed on a display unit of an image forming apparatus according to an embodiment.

### DESCRIPTION OF THE EMBODIMENTS

Hereafter, embodiments of the present disclosure will be described in detail with reference to the accompanying drawings. It will be understood that the following embodiments are illustrative only and not limiting the present disclosure related to the claims, and not all the combinations of the features described in the embodiments are necessary to solve the problems above. Various other features and advantages of the present disclosure will be apparent from the description below with reference to the accompanying drawings. In the accompanying drawings, the same reference numerals denote the same or similar structures.

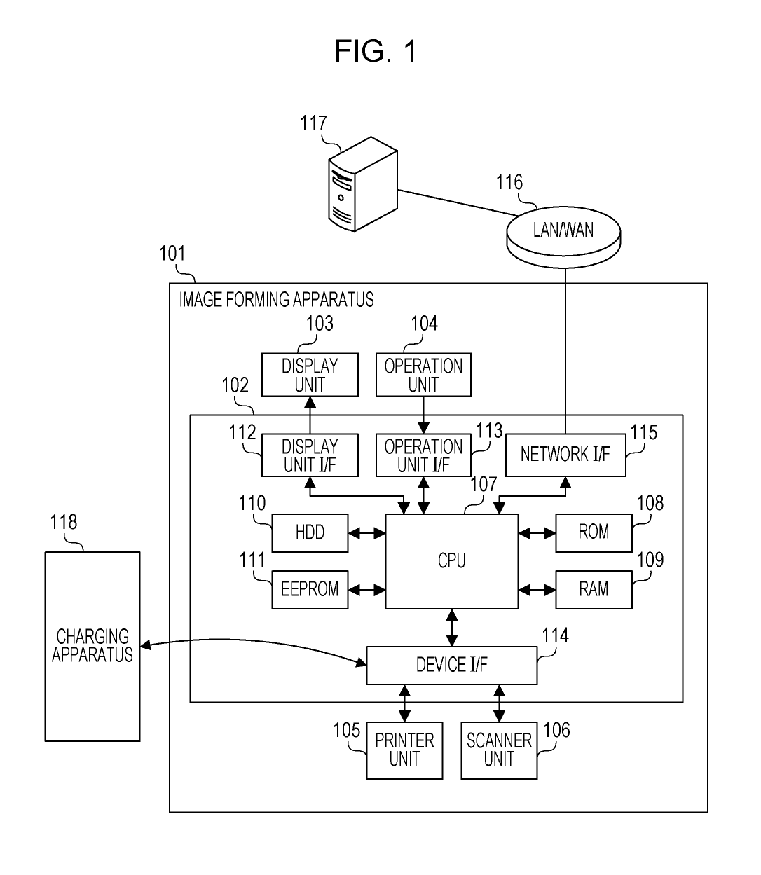

FIG. 1 is a block diagram illustrating a system configuration which includes an image forming apparatus 101 according to an embodiment of the present disclosure.

The image forming apparatus 101 includes a controller unit (a control unit) 102, a display unit 103, an operation unit 104, a printer unit 105, and a scanner unit 106. The display unit 103 includes an LED, a liquid crystal display, etc., and displays operation contents, a state of the apparatus, etc. The operation unit 104 accepts operations from a user via operation buttons etc. The operation unit 104 can include a plurality of operation buttons, and can be implemented as a touch display together with the display unit 103. The printer unit 105 is connected via a device I/F 114 of the controller unit 102 and prints an image on a sheet based on image data transmitted from the controller unit 102 under a print instruction from the controller unit 102. The scanner unit 106 is connected via the device I/F 114 of the controller unit 102, and performs a scanning operation under a scan instruction from the controller unit 102. The scanner unit 106 then transmits image data obtained by scanning to the controller unit 102.

The controller unit 102 includes a CPU 107, ROM 108, RAM 109, a HDD 110, EEPROM 111, a display unit I/F 112, an operation unit I/F 113, and the device I/F 114, The CPU 107 is an execution medium of a control program stored in the image forming apparatus 101, and controls operations of each part connected to the controller unit 102 via each I/F, memory of the storage medium, etc. The ROM 108 is read-only memory storing a boot program necessary for starting the system, etc. The RAM 109 is volatile memory that provides a rasterization area for the control program, as well as a work memory. The HDD 110 is a storage medium, such as a magnetic disk, which stores a control program, image data, etc. The EEPROM 111 is nonvolatile memory that stores, in a nonvolatile manner, setting values etc. which are needed when running the control program. IDs, passwords, etc. necessary for user management described below are also stored in the EEPROM 111.

The device I/F 114 controls input and output with respect to the devices connected to the controller unit 102, i.e., the printer unit 105, the scanner unit 106, and a charging apparatus 118. The device I/F 114 can be implemented as a bus structure to which a plurality of devices is connectable, as well as segmented into a plurality of I/Fs, such that the I/F is provided one-for-one to each device to be connected. The display I/F 112 outputs various types of information to the display unit 103. The operation unit I/F 113 accepts information input from the operation unit 104. The image forming apparatus 101 is connected to a LAN/WAN 116 via a network I/F 115, and accepts a print job, etc. from a PC 117 which is connected to the LAN/WAN 116. The network I/F 115 can include wireless communication capability.

The image forming apparatus 101 communicates with a charging apparatus 118 via the device I/F 114, and performs a withdrawal process of money, etc. from an amount of money inserted into the charging apparatus 118. The charging apparatus 118 is connected to the image forming apparatus 101, and is used to collect the fee paid by the user to use the image forming apparatus 101. The charging apparatus 118 notifies the image forming apparatus 101 of the balance of money that the user inserted into the charging apparatus 118, and returns the inserted money to the user under instructions from the image forming apparatus 101. The charging apparatus 118 withdraws an amount from the money, as instructed by the image forming apparatus 101, from the balance of money the user inserted into the charging apparatus 118 based on the function of the image forming apparatus 101 used by the user.

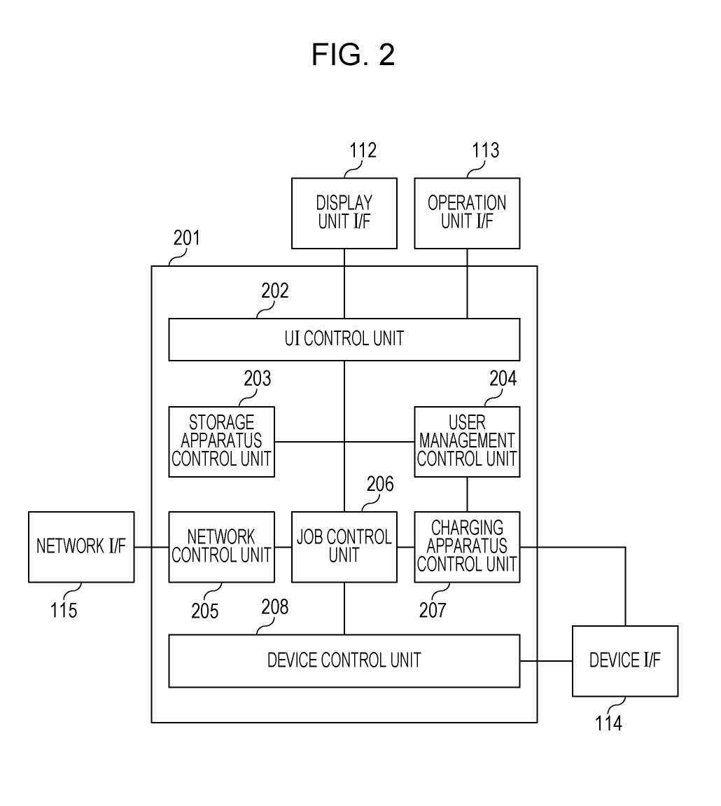

FIG. 2 is a block diagram illustrating a module configuration of a control program (controller software) of the image forming apparatus 101 according to an embodiment.

A function of controller software 201 is implemented by the CPU 107 extracting the control program from the HDD 110 to the RAM 109 and executing it. The controller software 201 includes a UI control unit 202, a storage apparatus control unit 203, a user management control unit 204, a network control unit 205, a job control unit 206, a charging apparatus control unit 207, and a device control unit 208.

The UI control unit 202 instructs display of a screen to the display unit 103 via the display unit I/F 112. The UI control unit 202 accepts operations of the user via the operation unit 104 via the operation unit I/F 113. The UI control unit 202 accepts input of an ID and a password from the user, and notifies the user management control unit 204 of a login request. The UI control unit 202 also accepts various settings of the image forming apparatus 101 and notifies the storage apparatus control unit 203 of setting values. The storage apparatus control unit 203 reads and writes image data, various setting values, etc. to the HDD 110 or the EEPROM 111 under reading and writing instructions from other control units.

When a login request is issued by the UI control unit 202, the user management control unit 204 refers to a user management table stored in the HDD 110, determines whether the user is a valid user registered therein, and executes login control. The user management control unit 204 accepts the login request provided from the charging apparatus control unit 207, and executes the login control.

The network control unit 205 transmits and receives data to and from the LAN/WAN 116 via the network I/F 115. A print job from the PC 117 is submitted to the job control unit 206 after it's accepted by the network control unit 205. The job control unit 206 accepts submission of the print job from the UI control unit 202 or the network control unit 205, acquires various settings and login information stored in the HDD 110, and executes the job. In an execution process of the job, the job control unit 206 notifies the device control unit 208 of a print instruction and a scan instruction. The device control unit 208 notifies the charging apparatus control unit 207 of information necessary for charging.

The charging apparatus control unit 207 communicates with the charging apparatus 118 via the device I/F 114. When notification of inserted money is received from the charging apparatus 118, the charging apparatus control unit 207 issues a login request to the user management control unit 204. The charging apparatus control unit 207 receives information necessary for the charge from the job control unit 206, calculates necessary money in accordance with the information, and instructs the charging apparatus 118 to withdraw the necessary money from the balance of money.

The device control unit 208 communicates with the printer unit 105 or the scanner unit 106 via the device I/F 114. Upon receipt of a print instruction from the job control unit 206, the device control unit 208 causes the print unit 105 to start a print operation. Upon receipt of a scan instruction from the job control unit 206, the device control unit 208 causes the scanner unit 106 to start a scan operation. Various states caused during operation of the print unit 105 or the scanner unit 106 are provided to the job control unit 206 from the device control unit 208.

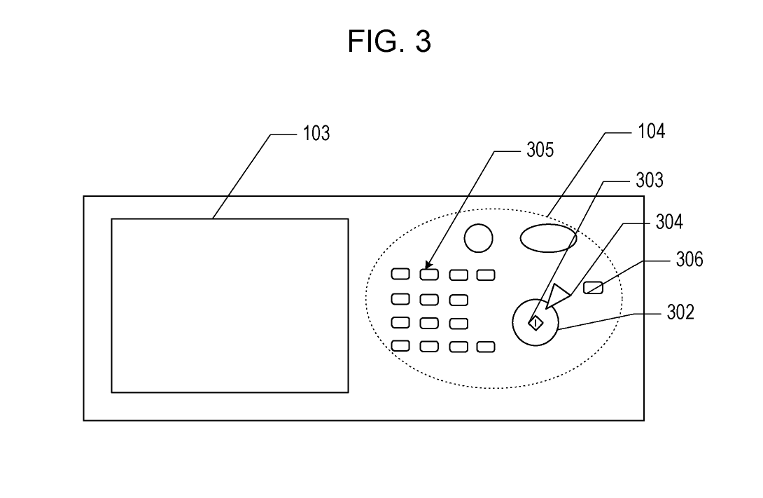

FIG. 3 is a top view of an operation panel provided with the display unit 103 and the operation unit 104 of the image forming apparatus 101 according to an embodiment.

The display unit 103 is constituted by a touch panel sheet attached to liquid crystal, and displays an operation screen and soft keys. When one of the displayed keys is pressed, the display unit 103 transfers the position information of the key to the CPU 107 via the display unit I/F 112. The operation unit 104 includes various operation buttons, and a start key 302 is used to instruct job input of selected functions, for example, starting reading of an original image when a copy function is selected. A bicolor (green and red) LED lamp 303 is provided at the center of the start key 302. The color of the bicolor LED lamp 302 indicates usability of the start key 302. The stop key stops operation of the job under operation. A numeric keypad 305 is constituted by a group of buttons of numbers and characters, and is used to instruct setting of the number of copies and switching screens of the display unit 103. The user presses a user mode key 306 when the user wants to display a screen on which the user will perform settings of the apparatus on the display unit 103.

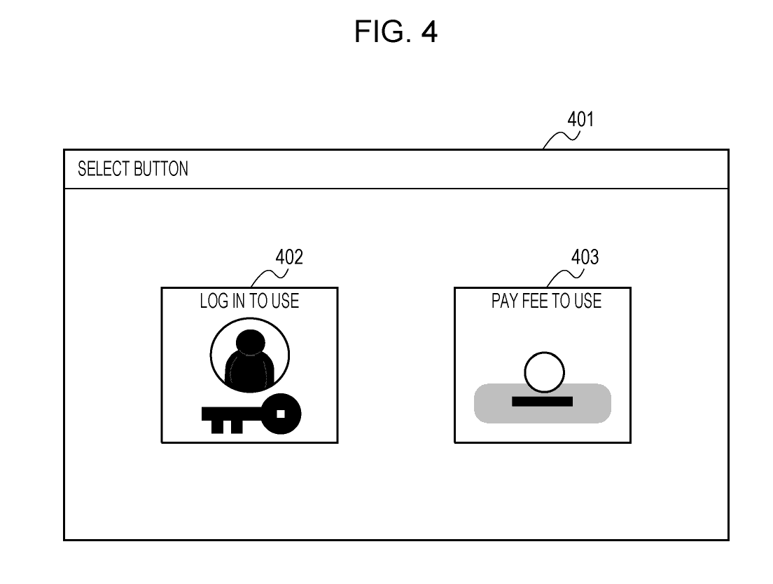

FIG. 4 illustrates an example of a user selection screen displayed on the display unit 103 when the image forming apparatus 101 according to an embodiment is started.

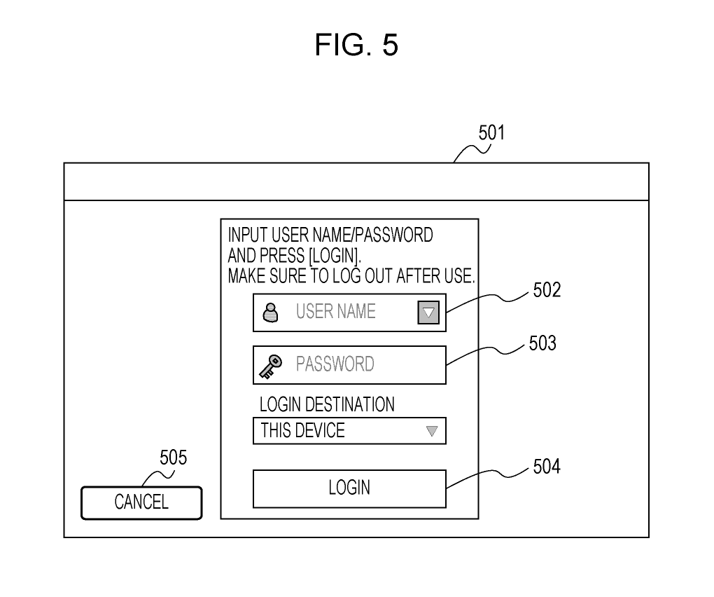

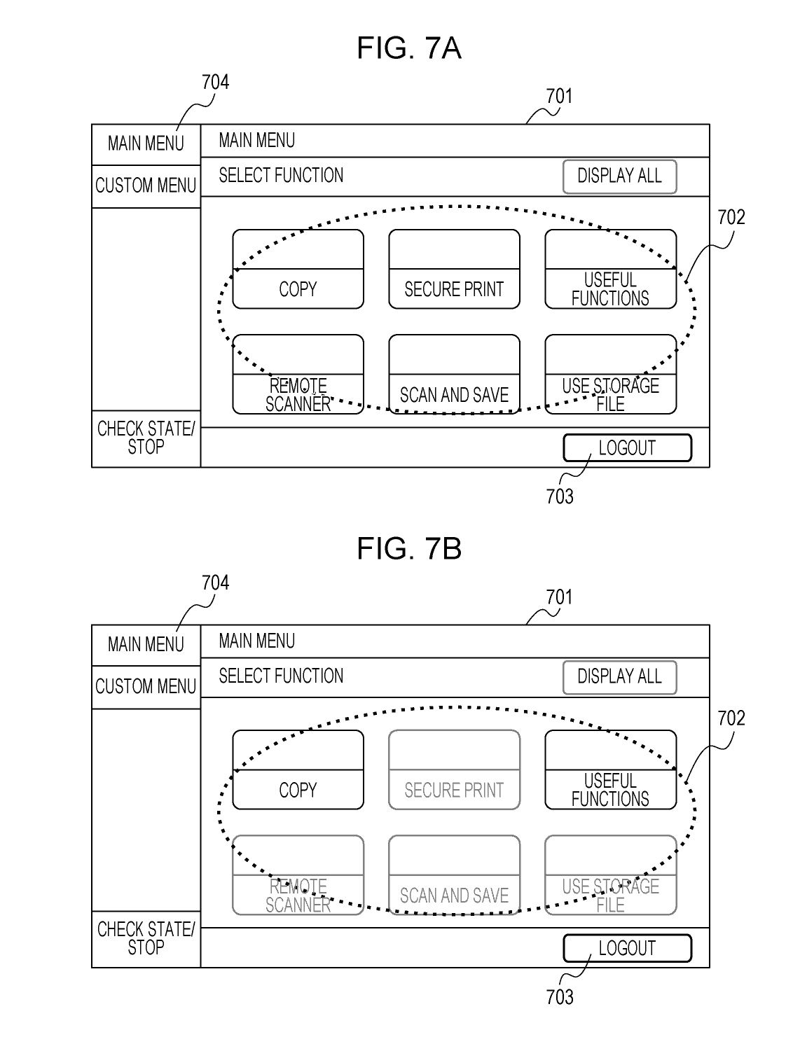

The user selection screen 401 is displayed on the display unit 103 by the UI control unit 202. On the user selection screen 401, either a “log in to use” button 402 or a “pay fee to use” button 403 is selectable. When the user presses the “log in to use” button 402, the user can use the image forming apparatus after inputting an ID and a password to log in. When the user presses the “pay fee to use” button 403, the user can use the image forming apparatus after inserting money into a money collecting device, e.g., charging apparatus 118). When the “log in to use” button 402 is pressed, a login screen 501 on which the user inputs an ID and a password, as illustrated in FIG. 5, is displayed by the UI control unit 202. When the “pay fee to use” button 403 is pressed, the UI control unit 202 notifies the user management control unit 204 of a guest user ID (here, “coin” for example). The UI control unit 202 then displays a function selection screen 701 on which functions that the guest user can use are displayed, as illustrated in FIG. 7B.

FIG. 5 illustrates an example of the login screen 501 displayed on the display unit 103 of the image forming apparatus 101 according to an embodiment.

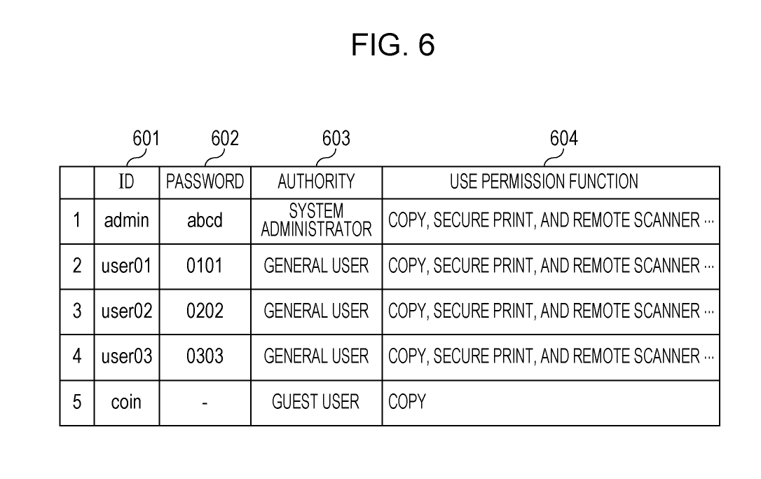

The login screen 501 includes an ID input section 502, a password input section 503, a login button 504, and a cancel button 505. The ID input section 502 accepts input of a user ID (user-identification information) from the user. The password input section 503 accepts input of a password from the user. When it is detected that the login button 504 has been pressed, the UI control unit 202 notifies the user management control unit 204 of information input into the ID input section 502 and the password input section 503. If these pieces of input information are registered in the user management table (FIG. 6), the user management control unit 204 permits login of the user. If the ID input section 502 or the password input section 503 is blank, the user can be prevented from pressing the login button 504.

Next, the ID to be input into the ID input section 502 or the password to be input into the password input section 503 will be described.

FIG. 6 is a conceptual diagram of a user management table stored in the HDD 110 of the image forming apparatus 101 according to an embodiment.

The user management table is stored in the EEPROM 111, for example, and IDs 601, passwords 602, authority 603, and use permission function 604 are registered for every user. The user management control unit 204 acquires the user management table when necessary via the storage apparatus control unit 203.

The ID 601 is identification information for uniquely identifying the user, and the password 602 is a value for discriminating whether the user is valid. A specific ID (coin) is reserved for login from the charging apparatus 118, and no password exists with respect to the specific ID. In the present embodiment, the specific ID for login from the charging apparatus 118 is “coin”. The authority 603 that the user has is set to each ID. In the embodiment, a system administrator, a general user, and a guest user exist as the authority 603. The use permission function 604, which is information for identifying the function which the user can use, is defined for each ID. While these pieces of information are shown in a single table, they can be stored in separate tables in the present embodiment.

FIGS. 7A and 7B each illustrate an example of a main menu screen displayed on the display unit 103 when a user logs into the image forming apparatus 101 according to an embodiment. FIG. 7A illustrates a main menu screen when the user who is set to use all the functions by the use permission function 604 of FIG. 6 logs in. FIG. 7B illustrates an example of a screen when a quest user who is set to use only a copy function by the use permission function 604 of FIG. 6 logs in.

A main menu screen 701 is displayed on the display unit 103 by the UI control unit 202, and the user selects a function to be used via the main menu screen 701. A group of buttons 702 illustrates shift buttons to settings screens of functions that the logged-in user can use. This screen is displayed based on the use permission function 604 for the logged-in user. For example, a user whose ID 601 illustrated in FIG. 6 is “user 01” is permitted to use all the functions. Therefore, when the user whose ID 601 is “user 01” logs in, all the shift buttons 702 to the settings screens of each function will be validated and displayed on the display unit 103 (FIG. 7A).

A guest user whose ID 601 is “coin” is permitted by the use permission function 604 to only use a copy function. Therefore, when the guest user whose ID is “coin” logs in, only the copy function and a “useful functions” button will be validated among shift buttons 702 to the settings screen of each function, and displayed on the display unit 103 (FIG. 7B).

Under such display control, the user can shift to the settings screen (not illustrated) of the function that the user wants to use by pressing any of the shift buttons 702 to the settings screen of available functions that has been validated and displayed on the main menu screen 701. Then, after performing various settings on the settings screen of the function, the user presses the start key 302 of the operation unit 104 and a job of the function being selected is submitted to the job control unit 206.

A main menu button 704 and a logout button 703 are displayed on the same location even after shifting to the settings screen of each function, and accept input from the user. When the main menu button 704 is pressed on the settings screen of each function, the function selection screen 701 will be displayed. When the logout button 703 is pressed, the currently logged-in user slogged out.

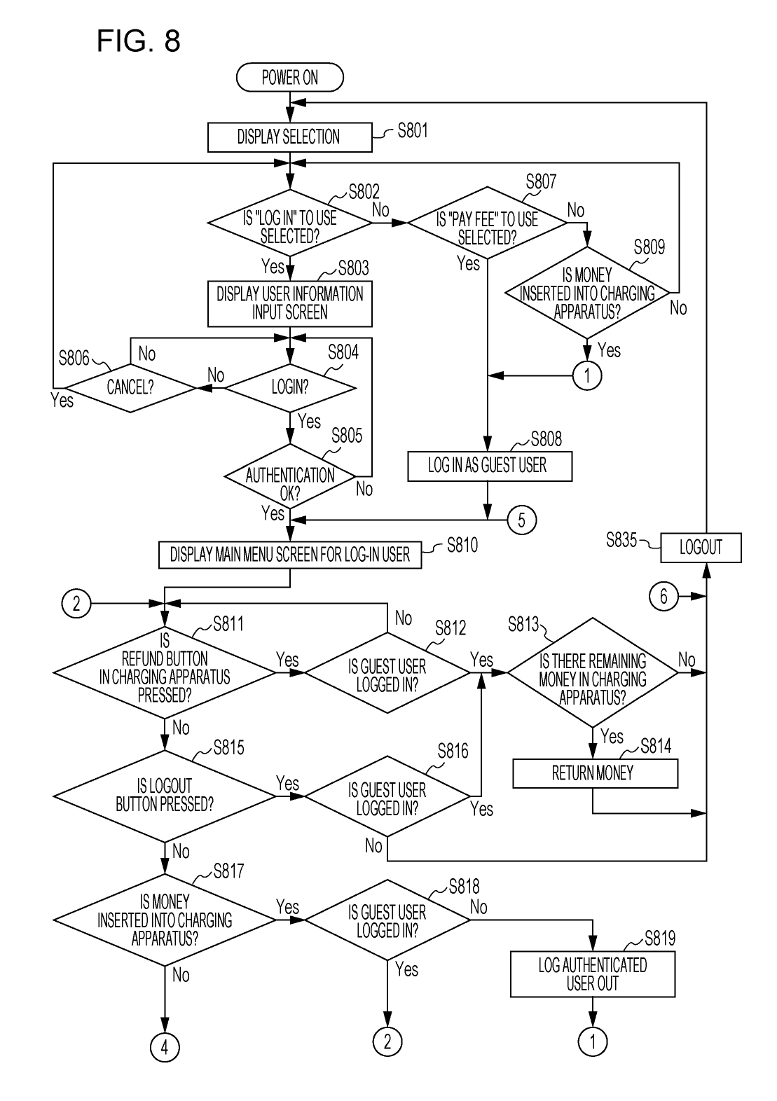

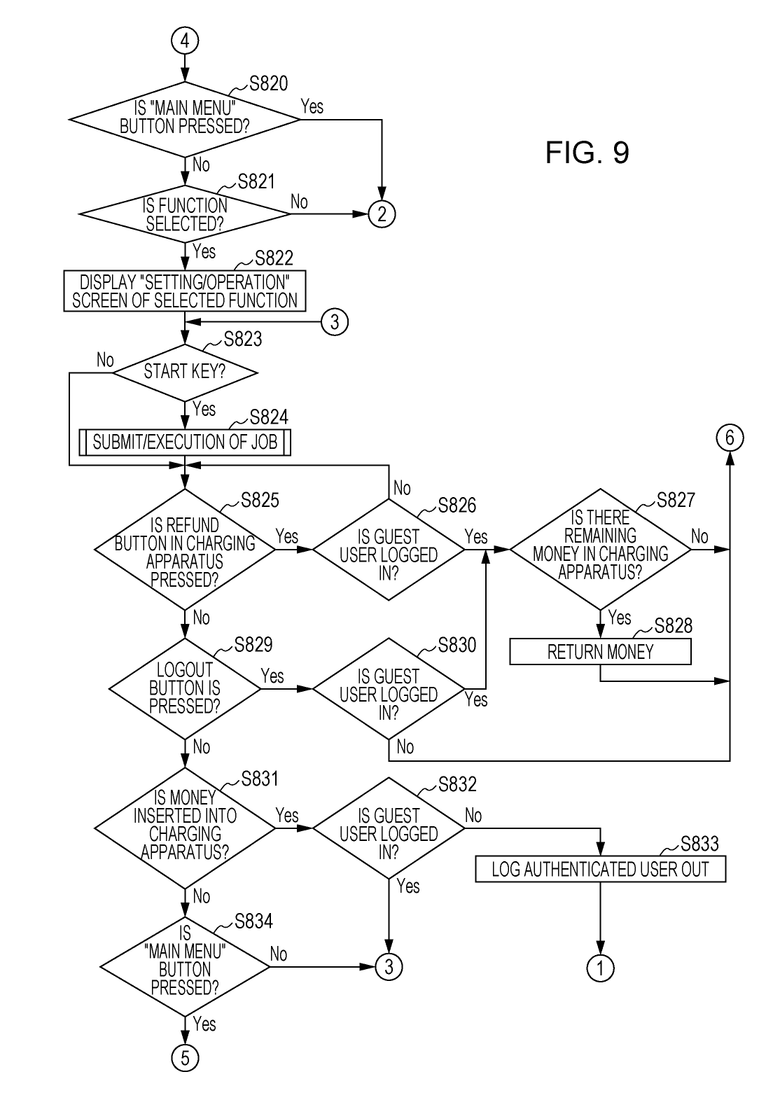

FIGS. 8 and 9 are flowcharts illustrating processes after the user logs into and until the user logs out of the image forming apparatus 101 according to an embodiment. The process illustrated in these flowcharts are implemented when the CPU 107 extracts and executes the control program stored in the HDD 110 to the RAM 109. This process is started when the image forming apparatus 101 is powered on and started.

First, in S801, the CPU 107 functions as the control unit 202 and displays the user selection screen 401, for example, illustrated in FIG. 4 on the display unit 103. Next, the process proceeds to S802 in which the CPU 107 determines whether the “log in to use” button 402 has been pressed on the screen of FIG. 4. If the CPU 107 determines that the “log in to use” button 402 has been pressed, the process proceeds to S803, otherwise the process proceeds to S807.

In S803, the CPU 107 functions as the UI control unit 202 and causes the input screen 501 of user information, for example, illustrated in FIG. 5, to be displayed on the display unit 103. Then the process proceeds to S804. In S804, the CPU 107 determines whether a “login” button 504 has been pressed. If the CPU 107 determines that the “login” button 504 has been pressed, the process proceeds to S805 and the CPU 107 authenticates the user in accordance with the information input on the input screen 501. This user authentication is implemented when the CPU 107 functions as the user management control unit 204.

Specifically, the CPU 107 functions as the user management control unit 204 in S805 and compares the ID and the password input on the input screen 501 with the ID and the password in the user management table (FIG. 6) of the HDD 110. If the ID and the password input on the input screen 501 are registered in the user management table, the CPU 107 determines that user authentication has succeeded, and the process proceeds to S810. If the ID and the password input on the input screen 501 are not registered in the user management table, the CPU 107 determines that user authentication has failed, and the process proceeds to S804. If the CPU 107 determines in S804 that the “login” button 504 has not been pressed, the process proceeds to S806, in which it is determined whether a cancel button 505 has been pressed on the screen of FIG. 5. If the CPU 107 determines that the cancel button 505 has been pressed, the process proceeds to S802, otherwise, the process proceeds to S804.

In S807, the CPU 107 functions as the UI control unit 202 and determines whether the “pay fee to use” button 403 has been pressed on the user selection screen 401 of FIG. 4. If the CPU 107 determines that the “pay fee to use” button 403 has been pressed, the process proceeds to S808. In S808, the CPU 107 defines the user information as a guest user (ID=“coin”), and then the CPU 107 functions as the user management control unit 204 and compares that user ID and the ID and the password in the user management table (FIG. 6). As described above, no password exists for a guest user. The CPU 107 then functions as the UI control unit 202 and checks that the guest user has logged in, and the process then proceeds to S810.

In S807, if it is determined that the “pay fee to use” button 403 has not been pressed, the process proceeds to S809, in which the CPU 107 functions as the charging apparatus control unit 207 and determines whether money has been inserted into the charging apparatus 118. If the CPU 107 determines that money has been inserted into the charging apparatus 118, the process proceeds to S808, in which the CPU 107 defines the user information as a guest user (ID=“coin”) and checks that the guest user has logged in. Then, the process proceeds to S810. If the CPU 107 determines in S809 that no money has been inserted into the charging apparatus 118, the process proceeds to S802.

With the process so far, a user who wants to use the image forming apparatus 101 by paying money can log into the image forming apparatus 101 as a guest user before paying money. Even if an authenticated user has logged in, the guest user can log into the image forming apparatus 101 by inserting money into the charging apparatus 118.

In S810, the CPU 107 functions as the UI control unit 202 and displays the main menu screen 701 as illustrated in. FIG. 7A or FIG. 7B on the display unit 103 in accordance with the information about the logged-in user checked in S805 or S808. That is, if the user is the user authenticated in S805, the main menu screen 701 illustrated in FIG. 7A is displayed, and if the user is the guest user who logged in in S808, the main menu screen 701 illustrated in FIG. 7B is displayed.

Next, the process proceeds to S811, in which the CPU 107 functions as the charging apparatus control unit 207 and determines whether a refund button of the charging apparatus 118 has been pressed. If the CPU 107 determines that the refund button has been pressed, the process proceeds to S812, otherwise, the process proceeds to S815. In S812, the CPU 107 functions as the user management control unit 204 and determines whether a guest user is currently logged in based on the refund button being pressed. If the CPU 107 determines that the currently logged-in user is a guest user, the process proceeds to S813, and otherwise, the process proceeds to S811.

In S813, the CPU 107 functions as the charging apparatus control unit 207 and determines whether the charging apparatus 118 contains the balance of money. If the CPU 107 determines that there is the balance of money, the process proceeds to S814, in which the CPU 107 functions as the charging apparatus control unit 207 and notifies the charging apparatus 118 to return the remainder of the money, and the process proceeds to S835. The charging apparatus 118 then returns the remainder of the money. If the CPU 107 determines in S813 that there is no balance of money in the charging apparatus 118, the process proceeds to S835, in which the CPU 107 functions as the user management control unit 204 and executes a logout process of the guest user who is currently logged in, and then the process returns to S801.

In S815, the CPU 107 functions as the UI control unit 202 and determines whether the logout button 703 has been pressed on the main menu screen 701 of FIGS. 7A and 7B. if the CPU 107 determines that logout button 703 has been pressed, the process proceeds to S816, otherwise, the process proceeds to S817. In S816, the CPU 107 functions as the user management control unit 204 and determines whether a guest user is currently logged in. If the CPU 107 determines that the currently logged-in user is a guest user, the process proceeds to S813 and the CPU 107 executes the process described above, otherwise, the process proceeds to S835 and the CPU 107 executes a logout process of the user. Then, the process proceeds to S801.

In S817, the CPU 107 functions as the charging apparatus control unit 207 and determines whether money has been inserted into the charging apparatus 118. If the CPU 107 determines that money has been inserted, the CPU 107 defines the user information as the guest user (ID=“coin”) and the process proceeds to S818. Otherwise, the process proceeds to S820 (FIG. 9). In S818, the CPU 107 functions as die user management control unit 204 and determines whether the currently logged-in user is a guest user. If the CPU 107 determines that the currently logged-in user is a guest user, it is considered that the user has added money to the charging apparatus 118, the process returns to S811, and the CPU 107 executes the process described above. If the CPU 107 determines in S818 that the currently logged-in user is not a guest user, the process proceeds to S819. In S819, since the currently logged-in user is not a guest user, the CPU 107 functions as the user management control unit 204 and logs out the user who is currently logged in and who logged in by user authentication, and the process proceeds to S808.

Next, the process proceeds to a flowchart of FIG. 9.

In S820, the CPU 107 functions as the UI control unit 202 and determines whether the main menu button 704 has been pressed on the main menu screen 701 of FIGS. 7A and 7B. If the CPU 107 determines in S820 that the main menu button 704 has been pressed, since the currently displayed screen is the main menu, the process proceeds to S811 (FIG. 8), and the CPU 107 executes the process described above. If the CPU 107 determines that the main menu button 704 has not been pressed, the process proceeds to S821. In S821, the CPU 107 functions as the UI control unit 202 and determines whether any of the shift buttons 702 to the settings screen of each function has been pressed on the main menu screen 701, that is, whether a function desirable to the user has been selected. In S821, if the CPU 107 determines that any of the shift buttons 702 to the settings screen of each function has been pressed, the process proceeds to S822. Otherwise, the process proceeds to S811 and the process described above is executed.

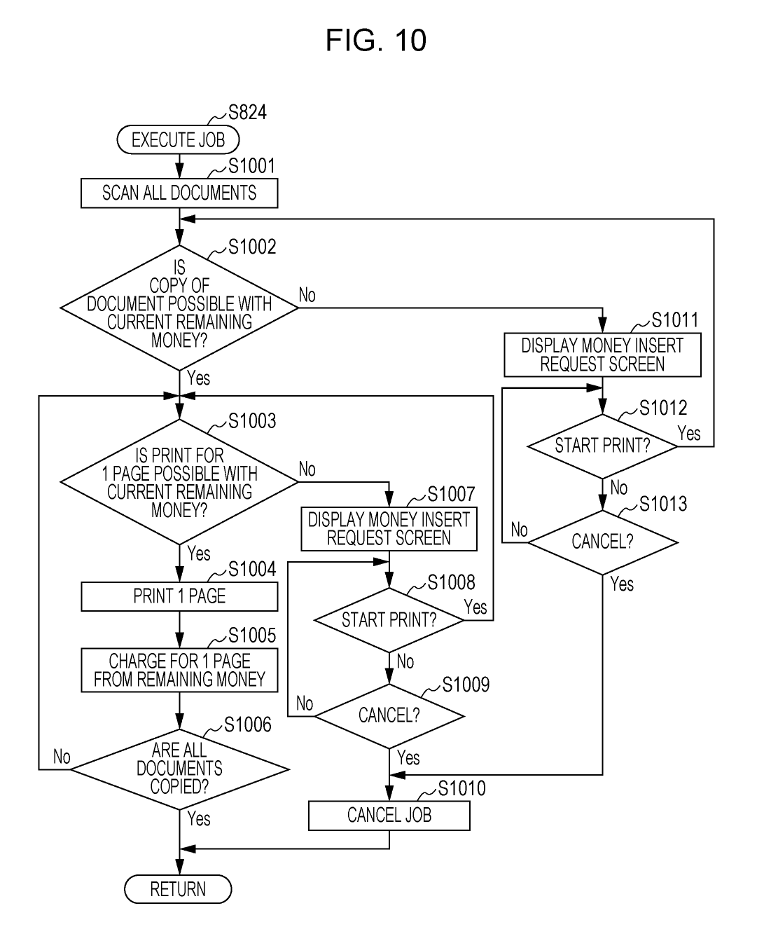

In S822, the CPU 107 functions as the UI control unit 202 and displays the setting screen (not illustrated) of the function selected in S821. Next, the process proceeds to S823 and the CPU 107 determines whether the start key 302 of the operation unit 104 has been pressed. If the CPU 107 determines that the start key 302 has been pressed, the process proceeds to S824, in which the CPU 107 functions as the job control unit 206 and accepts the submitted job. The CPU 107 acquires various settings or login information stored in the HDD 110, etc., executes the job, and then the process proceeds to S825. The process to be executed when the copy function is selected in S824 will be described below with reference to the flowchart of FIG. 10.

In S825, the CPU 107 functions as the charging apparatus control unit 207 and determines whether the refund button of the charging apparatus 118 has been pressed. If the CPU 107 determines that the refund button has been pressed, the process proceeds to S826, otherwise, the process proceeds to S829. In S826, the CPU 107 functions as the user management control unit 204 and determines whether the guest user is currently logged in. If the CPU 107 determines that the currently logged-in user is a guest user, the process proceeds to S827, otherwise, the process returns to S825.

In S827, the CPU 107 functions as the charging apparatus control unit 207 and determines whether the charging apparatus 118 has the balance of money. If the CPU 107 determines that the charging apparatus 118 has the remainder of the money, the process proceeds to S828, otherwise, the process proceeds to S835. In S828, the CPU 107 functions as the charging apparatus control unit 207 and notifies the charging apparatus 118 to return the remainder of the money. Then the process proceeds to S835. In this manner, the charging apparatus 118 returns the remainder of the money.

In S829, the CPU 107 functions as the UI control unit 202 and determines whether the logout button 703 has been pressed on the main menu screen 701 of FIGS. 7A and 7B. If the CPU 107 determines that the logout button 703 has been pressed, the process proceeds to S830, otherwise, the process proceeds to S831. In S830, the CPU 107 functions as the user management control unit 204 and determines whether the guest user is currently logged in. If the CPU 107 determines that the currently logged-in user is a guest user, the process proceeds to S827, otherwise, the process proceeds to S835.

In S831, the CPU 107 functions as the charging apparatus control unit 207 and determines whether the money has been inserted into the charging apparatus 118. If the CPU determines that money has been inserted into the charging apparatus 118, the CPU 107 notifies the user management control unit 204 of the user information as guest user (ID=“coin”), and the process proceeds to S832. If the CPU determines in S831 that no money has been inserted into the charging apparatus 118, the process proceeds to S834.

In S832, the CPU 107 functions as the user management control unit 201 and determines whether the currently logged-in user is a guest user. If the CPU 107 determines that the currently logged-in user is a guest user, it is considered that the user has inserted money to the charging apparatus 118, the process proceeds to S823, and the CPU 107 executes the process described above. If the CPU 107 determines in S832 that the currently logged-in user is not a guest user, the process proceeds to S833. In S833, since the currently logged-in user is not a guest user, the CPU 107 logs out the user who is currently logged in, and the process proceeds to S808, in which the CPU 107 executes the process described above.

In S834, the CPU 107 functions as the UI control unit 202 and determines whether the main menu button 704 has been pressed on the main menu screen 701 of FIGS. 7A and 7B. If the CPU 107 determines that the main menu button 704 has been pressed, the process returns to S810 (FIG. 8), in which the CPU 107 executes the above-described process. If the CPU 107 determines in S834 that the main menu button 704 has not been pressed, the process returns to S823, in which the CPU 107 executes the above-described process.

Per the above-described process, when the refund button of the charging apparatus 118 is pressed or logout is instructed while a guest user is logged in, the balance of money in the charging apparatus 118 is returned, and the logged-in user is logged out. If another user inserts money into the charging apparatus 118 while an authenticated user is logged in, the currently logged-in authenticated user is logged out and the user who inserted money is logged in.

FIG. 10 is a flowchart illustrating an example of a process in which the image forming apparatus 101 according to an embodiment executes a job in S824 of FIG. 9. Here, a case in which a guest user uses a copy function will be described as an example. The process illustrated in these flowcharts are implemented when the CPU 107 extracts and executes the control program stored in the HDD 110 to the RAM 109.

This process is started when a guest user logs in in S807 or S809 of FIG. 8, selects a copy function in S822 (FIG. 9), and presses a start key 302 in S823.

First, in S1001, the CPU 107 communicates with the scanner unit 106 via the device I/F 114, and instructs scanning of a document set in the scanner unit 106. Next, the process proceeds to S1002, in which the CPU 107 functions as the job control unit 206 and determines whether all the documents scanned in S1001 can be copied (printed) with the money inserted into the charging apparatus 118 at that time. The CPU 107 totals information about all the pages of the scanned documents, e.g., the number of sheets to be printed, the sheet size, and the color mode, from the number of sheets and print setting of the scanned documents in S1001. The CPU 107 then functions as a charging apparatus control unit 207 and calculates, based on the information, the money necessary for copying all the documents. The CPU 107 acquires money (the balance of money) which has been inserted into the charging apparatus 118 via the device I/F 114. The CPU 107 functions as the charging apparatus control unit 207 and, based on these pieces of information, determines whether all the documents can be copied with the money (the balance of money) inserted into the charging apparatus 118. If the CPU 107 determines in S1002 that all the documents can be copied, the process proceeds to S1003, otherwise, the process proceeds to S1011.

In S1003, the CPU 107 functions as the job control unit 206 and determines whether the next 1 page is printable with the money inserted into the charging apparatus 118 at that time. The amount of money necessary for printing of the page is calculated based on the information on the page to be printed, e.g., the number of sheets to be printed, the sheet size, and the color mode. The CPU 107 acquires money (the balance of money) that has been inserted into the charging apparatus 118 via the device I/F 111. The CPU 107 then determines whether the next page is printable based on these pieces of information. If the CPU 107 determines that the page is printable, the process proceeds to S1004, otherwise, the process proceeds to S1007.

In S1004, the CPU 107 functions as the device control unit 208, communicates with the printer unit 105 via the device I/F 114, and executes printing of the page. The process then proceeds to S1005, in which the CPU 107 functions as the charging apparatus control unit 207 and instructs the charging apparatus 118 to withdraw the money for printing 1 page from the balance of money based on the information necessary for charging, e.g., the number of sheets to be printed, sheet size, and color mode. The CPU 107 calculates the necessary money based on the information necessary for charging, and instructs withdrawal to the charging apparatus 118.

The process then proceeds to S1006, in which the CPU 107 functions as the job control unit 206 and determines whether copying of all the documents has completed. If the CPU 107 determines that copying of all the documents has completed, the CPU 107 completes this process. If the CPU 107 determines in S1006 that copying of all the documents has not completed, the process returns to S1003, and the CPU 107 executes the process described above.

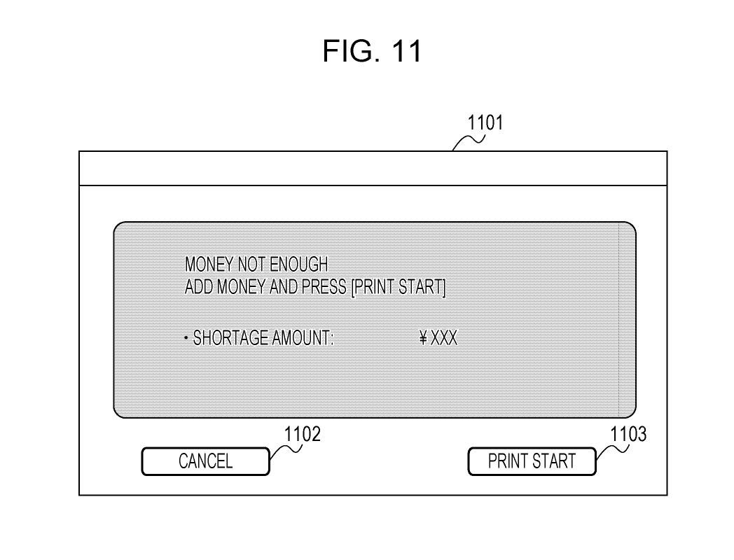

In S1003, if the CPU 107 determines that the next page is not printable with the balance of money at that time, in S1007, a screen indicating that the amount of money necessary for printing is insufficient, for example, a balance insufficient screen 1101 illustrated in FIG. 11, is displayed on the display unit 103.

FIG. 11 illustrates an example of a screen for notifying a user of shortage of money displayed on the display unit 103 of the image forming apparatus 101 according to an embodiment. The screen displays that the balance of money for printing to copy etc. is insufficient, as well as the amount of money required.

Next, the process proceeds to S1008, where the CPU 107 functions as the UI control unit 202 and determines whether a print start button 1103 on the balance insufficient screen 1101 has been pressed. If the CPU 107 determines that the print start button 1103 has been pressed, the process proceeds to S1003, in which the CPU 107 executes the above-described process. If the CPU 107 determines in S1008 that the print start button 1103 has not been pressed, the process proceeds to S1009. In S1009, the CPU 107 functions as the UI control unit 202 and determines whether a cancel button 1102 on the balance insufficient screen 1101 has been pressed. If the CPU 107 determines that the cancel button 1102 has been pressed, the process proceeds to S1010, in which the CPU 107 cancels the copy job and the process is completed. If the CPU 107 determines in S1009 that the cancel button 1102 has riot been pressed, the process returns to S1008, in which the CPU 107 executes the above-described process.

In S1002, if the CPU 107 determines that the original is not printable with the balance of money at that time, the process proceeds to S1011, in which the CPU 107 executes the same process as those of S1007 to S1009 described above. That is, the CPU 107 displays, for example, the balance insufficient screen 1101 illustrated in FIG. 11 on the display unit 103 in S1011. The process then proceeds to S1012, where the CPU 107 functions as the UI control unit 202 and determines whether the print start button 1103 on the balance insufficient screen 1101 has been pressed. If the CPU 107 determines in S1008 that the print start button 1103 has been pressed, the process proceeds to S1002, and the CPU 107 executes the above-described process. If the CPU 107 determines that the print start button 1103 has not been pressed, the process proceeds to S1013. In S1013, the CPU 107 determines whether the cancel button 1102 on the balance insufficient screen 1101 of FIG. 11 has been pressed. If the CPU 107 determines that the cancel button 1102 has been pressed, the process proceeds to S1010, otherwise, the process proceeds to S1012.

As described above, according to the present embodiment, where both guest users and employees use the same image forming apparatus, the guest users can start using the image forming apparatus without inserting money into a charging apparatus in advance. Guest users who wants to perform, for example, their copy job, by paying money can know how much money is required to complete the job before starting the job. Therefore, their job will not be interrupted due to shortage of money during execution of the job.

If other users insert money in a state in which a user authenticated with an ID and a password is logged in, the user (a guest user) who inserted money can preferentially use the image forming apparatus.

Since the currently logged-in user can be logged out by an instruction to return money in the charging apparatus and an instruction by a logout button, a situation in which the currently log-in user is logged out while printing, for example, can be avoided.

### OTHER EMBODIMENTS

The present disclosure is applicable to a process in which a program that implements one or more functions of the above-described embodiments is supplied to a system or an apparatus via a network or a storage medium, and one or more processors in a computer of the system or the apparatus loads and executes the program. The present disclosure is also implementable in a circuit having one or more functions (e.g., ASIC).

The present disclosure is not limited to the above-described embodiments, and various modifications and changes can be made without departing from the spirit and scope of the present disclosure. According to the present disclosure, in an image forming apparatus which guest users can use by paying money and other users can use under authentication convenience of guest users who pay money to use the image forming apparatus is improved.

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-254091 filed Dec. 27, 2016, which is hereby incorporated by reference herein in its entirety.

What is claimed is:

1. An image forming apparatus connected to a charging apparatus that collects a fee, comprising:
a display unit;
an authentication unit configured to authenticate a user; and
a selection unit configured to cause a screen, displayed on the display unit, enabling a user to select between logging into the image forming apparatus based on authentication by the authentication unit or by paying a fee using the charging apparatus.

2. The image forming apparatus according to claim 1, further comprising a display control unit which, when the user selects to log into the image forming apparatus by paying the fee using the charging apparatus, displays, on the display unit, a function selection screen with a smaller number of selectable functions than in a case where the user logs into the image forming apparatus based on authentication by the authentication unit.

3. The image forming apparatus according to claim 2, further comprising:
a determination unit configured to determine, when execution of a function selected on the function selection screen is instructed, whether an amount of money necessary to execute the function has been inserted into the charging apparatus; and
a control unit configured to control execution of the selected function if the determination unit determines that the amount of money necessary to execute the selected function has been inserted into the charging apparatus.

4. The image forming apparatus according to claim 3, wherein if the determination unit determines that the amount of money necessary to execute the selected function has not been inserted into the charging apparatus, the control unit displays a screen on the display unit indicating a shortage of money.

5. The image forming apparatus according to claim 3, further comprising:
a calculation unit configured to calculate an amount of money necessary for each of a plurality of processes included in the selected function during execution of the selected function; and
a notifying unit configured to notify the charging apparatus of the calculated amount of money and to cause the calculated amount of money to be withdrawn from a balance of the inserted money,
wherein, when the balance of the inserted money becomes less than an amount of money necessary for any of the plurality of processes, the control unit displays a screen on the display unit indicating a shortage of money.

6. The image forming apparatus according to claim 5, wherein if the selected function is a copy function, the calculation unit calculates a fee necessary to print each page and the notifying unit notifies the charging apparatus of the fee for each page and causes the fee to be withdrawn from the balance of the inserted money.

7. The image forming apparatus according to claim 1, further comprising a login control unit which, when a second user inserts money into the charging apparatus while a first user is logged into the image forming apparatus based on authentication by the authentication unit, enables the second user to log into the image forming apparatus instead of the first user.

8. The image forming apparatus according to claim 7, wherein a refund operation is performed in the charging apparatus, the login control unit logs out the user who logged into the image forming apparatus by inserting money into the charging apparatus.

9. The image forming apparatus according to claim 7, wherein the login control unit is further configured to log out the user who logged into the image forming apparatus by inserting the money into the charging apparatus upon a logout operation of the user and to instruct the charging apparatus to return any remainder of the money.

10. A image forming apparatus that connects to a charging apparatus that collects a fee, comprising:
a login unit configured to enable a user to log into the image forming apparatus;
an operation unit configured to instruct return of money previously inserted into the charging apparatus; and
a control unit configured to log out a user currently logged into the image forming apparatus based on the instruction to return the money.

11. A control method of an image forming apparatus that is connected to a charging apparatus that collects a fee, the control method comprising:
authenticating a user; and
displaying, on a display, a screen enabling a user to select between logging into the image forming apparatus based on being authenticated or by paying a fee using the charging apparatus.

12. A non-transitory computer readable storage medium storing a program for causing a computer to execute a control method, the control method comprising;
authenticating a user; and
displaying, on a display, a screen enabling a user to select between logging into the image forming apparatus based on being authenticated or by paying a fee using the charging apparatus.
